(19) United States
(12) Patent Application Publication
(10) Pub. No.: US 2007/0281570 A1
(43) Pub. Date: Dec. 6, 2007

(54) Reduced weight flexible laminate material for lighter-than-air vehicles

(76) Inventors: Paul E. Liggett, Wooster, OH (US); James I. Mascolino, North Canton, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/443,327

(22) Filed: May 30, 2006

(51) Int. Cl. B32B 15/14

(52) U.S. Cl. 442/378; 442/64; 442/71; 442/85; 442/164; 442/366; 442/373; 442/374; 442/381; 244/24

(57) ABSTRACT

A laminate material for lighter-than-air vehicles includes at least one monofilament yarn layer, a high modulus film layer adjacent to said at least one monofilament layer and optionally including reinforcing fiber or inorganic filler, and a metallized coating adjacent to said high modulus film layer.

### TECHNICAL FIELD

The present invention is generally directed to lighter-than-air vehicles. In particular, the present invention is directed to an improved fabric laminate construction used with lighter-than-air vehicles. Specifically, the present invention is directed to a laminate construction that is light weight, possesses high strength characteristics and allows deployment of lighter-than-air vehicles at very high altitudes.

### BACKGROUND ART

Lighter-than-air vehicles include blimps, aerostats, manned and unmanned balloons, and high altitude airships, and are used in many different applications. The hull structure of the lighter than air (LTA) vehicle may be formed from a non-rigid, flexible laminated fabric. The laminated hull fabric may include a barrier film layer that helps to contain the lifting gas. Adhesives may be used to bond the layers together.

Non-rigid lighter-than air vehicles require a certain minimum shear modulus to prevent droop or torsional distortion of the hull. Historically, the necessary shear modulus has been achieved by a laminated hull fabric that includes a bias ply layer. While the bias ply contributes to the shear modulus and significantly increases the tear strength of the fabric laminate, the bias ply layer also increases the weight of the hull fabric.

Therefore, there is a need for a hull fabric that is lightweight while having good strength.

### SUMMARY OF THE INVENTION

In light of the foregoing, it is a first aspect of the present invention to provide a reduced weight flexible fabric laminate material for lighter-than-air vehicles.

It is another aspect of the present invention to provide a laminate material comprising at least one monofilament yarn layer, a barrier film layer adjacent to the at least one monofilament yarn layer, with adhesive optionally therebetween, and a metallized coating adjacent to the barrier film layer, wherein at least one of the barrier film layers or adhesive layers includes a reinforcing filler.

Yet another aspect of the present invention, which shall become apparent as the detailed description proceeds, is achieved by a laminate material comprising a straight ply monofilament yarn layer, a bias ply monofilament yarn layer secured to the straight ply layer by a first adhesive layer, a barrier film layer secured to the bias ply yarn layer by a second adhesive layer, a metal coating layer secured to the barrier film layer, and a clear film cover layer secured to the metal coating layer, wherein at least one of the first adhesive layer or second adhesive layer includes reinforcing filler, and wherein the weight of the bias ply monofilament yarn layer is reduced, when compared to the weight of a laminate having equivalent strength, but which doesn't include reinforcing filler.

Still another aspect of the present invention, which shall become apparent as the detailed description proceeds, is achieved by a laminate material comprising a straight ply monofilament yarn layer; a barrier film layer secured to the straight ply yarn layer and including reinforcing filler; a metal coating layer secured to the barrier film layer; and optionally, a clear film cover layer secured to the metal coating layer.

Yet another object of the present invention is attained by a lighter-than-air vehicle having a hull; the hull including a laminate material comprising a straight ply monofilament yarn layer; a barrier film layer secured to the straight ply yarn layer and including reinforcing filler; a metal coating layer secured to the barrier film layer; and optionally, a clear film cover layer secured to the metal coating layer.

Still another aspect of the present invention, which shall become apparent as the detailed description proceeds, is achieved by a lighter-than-air vehicle having a hull; the hull including a laminate material comprising a straight ply monofilament yarn layer, a bias ply monofilament yarn layer secured to the straight ply layer by a first adhesive layer, a barrier film layer secured to the bias ply yarn layer by a second adhesive layer, a metal coating layer secured to the barrier film layer, and a clear film cover layer secured to the metal coating layer, wherein at least one of the first adhesive layer or second adhesive layer includes reinforcing filler, and wherein the weight of the bias ply monofilament yarn layer is reduced, when compared to the weight of a laminate having equivalent strength, but which doesn't include reinforcing filler.

These and other objects of the present invention, as well as the advantages thereof over existing prior art forms, which will become apparent from the description to follow, are accomplished by the improvements hereinafter described and claimed.

### BRIEF DESCRIPTION OF THE DRAWINGS

For a complete understanding of the objects, techniques and structure of the invention, reference should be made to the following detailed description and accompanying drawings, wherein:

FIG. 1 is a perspective drawing of a lighter-than-air vehicle according to the present invention;

FIG. 2 is a perspective drawing of a laminate material in cross-section according to an embodiment of the present invention; and

FIG. 3 is a perspective drawing of a laminate material in cross-section according to another embodiment of the present invention

### BEST MODE FOR CARRYING OUT THE INVENTION

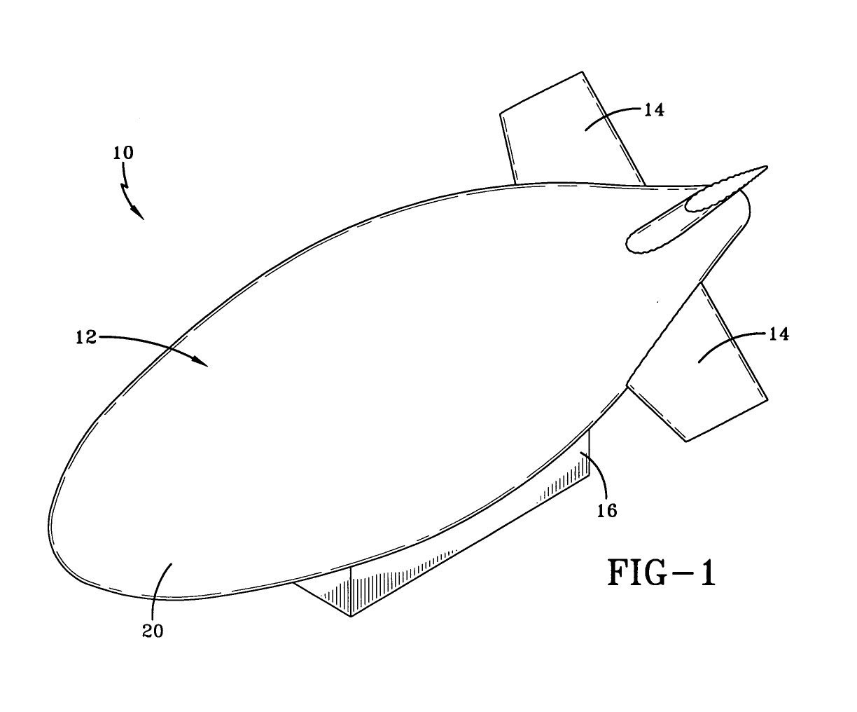

Referring now to the drawings and in particular to FIG. 1 it can be seen that a lighter-than-air vehicle according to the present invention is designated generally by the numeral 10. Although the vehicle 10 is likely to be a lighter-than-air vehicle it will be appreciated that the teachings of the present invention directed to a flexible laminate construction are applicable to any lighter-than-air vehicle such as an aerostat, a blimp, an airship or any lighter-than-air vehicle that is tethered or untethered. For example, the present invention could be used in hot-air balloons, regular helium balloons, weather balloons, sails, parachutes and any application where lightweight, high strength materials are needed for critical applications, while withstanding the rigors of an outdoor environment. In any event, the vehicle 10 includes a hull 12 with no fins or at least one stabilizing fin 14. If no fins are provided it is likely that a stabilizing element such as a vectored fan may be used. Although an oblong shape is shown for the hull, it will be appreciated that any shape—sphere, ellipse, parabolic, tear-drop, etc—could be used. The vehicle 10 may carry a payload 16 which may include personnel, surveillance devices, weather monitoring equipment, communications equipment, scientific research instrument and the like. The size of the payload generally varies in accordance with the size of the vehicle. The payload may be carried externally (as shown), internally or incorporated into the material such as for radar transmit/receive applications.

The vehicle 10 is constructed with an enclosing material that has many desirable properties. In general, these desirable properties are tear resistance, creep resistance, high strength, and light weight, which allows for an increase in payload size, and the ability to withstand extreme temperature and pressure variations. In view of these wide temperature and pressure variations the material also needs to be flexible in many conditions. It is also desirable that the laminate material be ozone and ultraviolet light resistant and have the necessary gas permeability characteristics. Resistance to tearing caused by bullets, punctures and the like is beneficial. It is desirable for the laminate material to have high altitude capabilities. It is believed that the constructions presented herein allow the vehicle 10 to operate at altitudes of within the troposphere and stratosphere. In certain embodiments, the enclosing material of vehicle 10 exhibits good thermal management and shear modulus, and is able to dissipate static electricity and provide lightning protection.

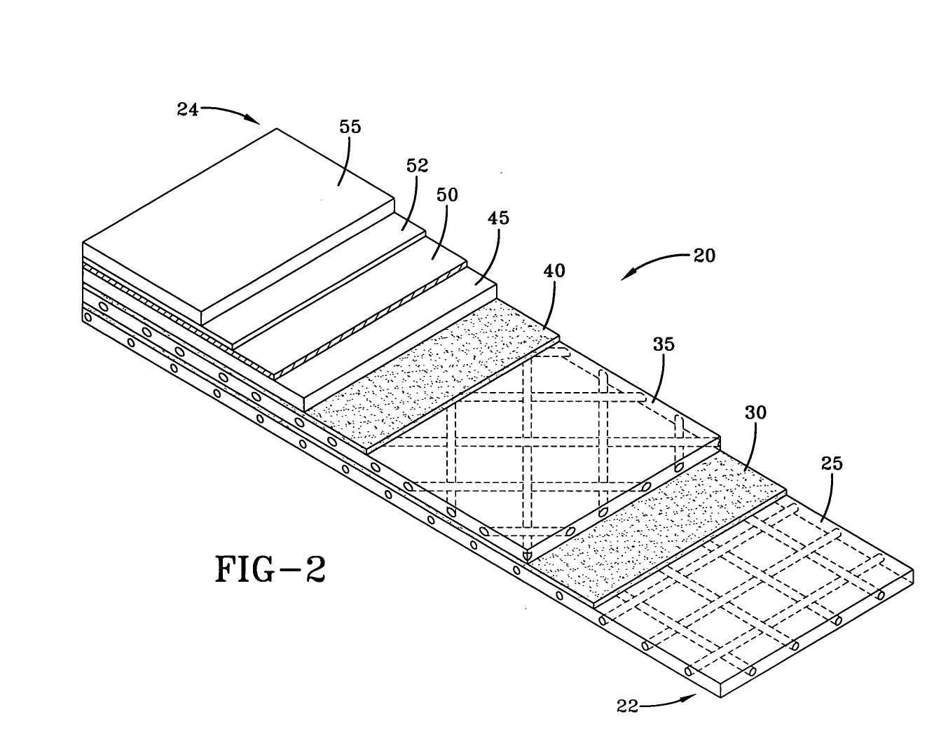

As best seen in FIG. 2, a laminate material according to one embodiment of the present invention is designated generally by the numeral 20. The material 20 has an interior surface 22 and an exterior surface 24, which is opposite the interior surface 22. Light weight laminate materials for lighter-than-air vehicles are described in U.S. Pat. No. 6,979,479 and co-pending U.S. patent application Ser. No. 11/231,569, each of which is hereby incorporated by reference in its entirety. The construction of the laminate material 20 will be described in general and then the various properties that each layer of material provides will be discussed in detail.

A straight ply monofilament yarn layer 25 forms the interior surface 22. An optional bias ply monofilament yarn layer 35 may be adhered to straight ply layer 25 with optional adhesive layer 30. When optional bias ply monofilament layer 35 is present, film layer 45 is adhered to bias play layer 35, and adhesive layer 40 is applied between bias ply layer 35 and a film layer 45. In one embodiment, film layer 45 is metallized. In other words, a metal coating may be applied to film layer 45 to form metal coating layer 50. In one embodiment, metal coating layer 50 may be adhered to the outer facing surface of film layer 45. In another embodiment, metal coating layer 50 may be adhered to the inner surface of film layer 45. In yet another embodiment, metal coating layer 50 may be adhered to both the inner and the outer surfaces of film layer 45. Reflectance enhancing layer 52 may be adhered to metal coating layer 50. Optionally, a clear film cover layer 55 may be adhered to metal coating layer 50, or to reflectance enhancing layer 52. Cover layer 55 may also form the exterior surface 24.

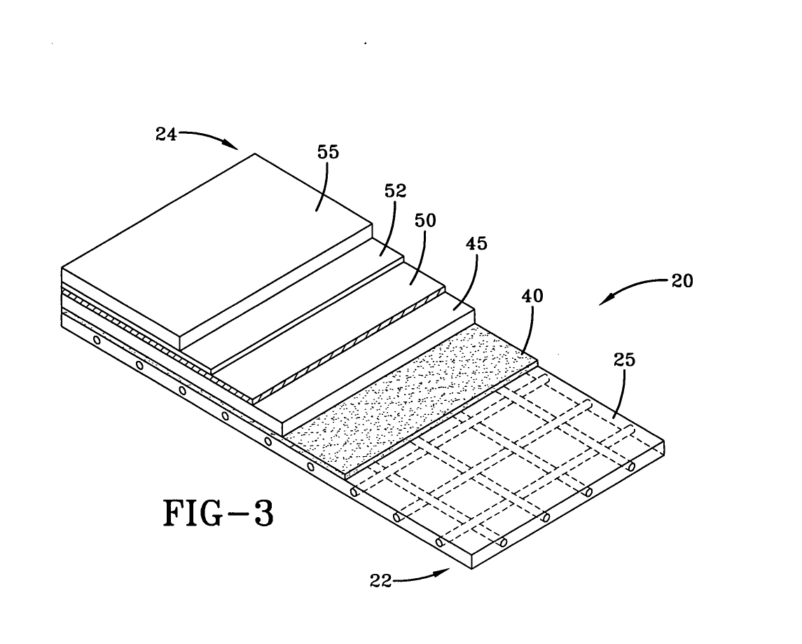

In another embodiment, shown in FIG. 3 and designated generally by the numeral 20, bias ply monofilament layer 35 and adhesive layer 30 are not present. In this embodiment, a straight ply monofilament yarn layer 25 forms the interior surface 22. An adhesive layer 40 is applied between straight ply layer 25 and barrier film layer 45.

In both embodiments, layer 25 may be described as a straight ply. By “straight ply” it is meant that the yarns are oriented at about 0 and 90 degrees to each other, and substantially parallel with the circumferential and axial directions of the airship hull. In certain embodiments, straight ply layer 25 provides the primary strength requirements for the airship structure.

The type of monofilament yarn employed in layer 25 is not particularly limited. Commercially available monofilament yarns include polyamides, polyesters, aramids, liquid crystal polymers, carbon, polybenzoxazole, and ultrahigh molecular weight polyethylene. In certain embodiments, a high tenacity yarn such as carbon, or those designated as M5® (DuPont), Vectran,® Zylon,® Dyneema,® and Spectra® may be employed. In one embodiment, the liquid crystal polymer fiber of layer 25 includes Vectran® or an equivalent material.

In one or more embodiments, straight ply layer 25 includes a woven fabric that has warp and fill yarns much like a cloth material. The liquid crystal polymer fiber yarns are advantageous in that they are strong yet light weight. A wide range of strengths are possible. Indeed, in one embodiment, the warp direction of straight ply layer 25 has a tensile strength of from about 200 to about 2000 lbs. per inch and in the fill direction a tensile strength of from about 120 to about 1200 lbs. per inch. The liquid crystal polymer fiber material has also excellent creep resistance and flex fatigue resistance. The weave pattern may provide intermittent gaps or periodic groups of bundled yarns for the purpose of reducing the overall weight of the laminate and to stop tearing in the event a bullet or other projectile punctures the laminate.

The at least one monofilament yarn layer may be woven or non-woven. Therefore, in another embodiment, straight ply layer 25 is non-woven. For example, the warp and fill yarns of layer 25 are layered and stitched, or knitted, together, rather than woven together.

Optional layer 35 may be described as bias ply. By “bias ply” it is meant that the warp and fill yarns are oriented at an angle of from about 30 to about 60 degrees to the warp and fill yarns of straight ply layer 25. In certain embodiments, bias ply layer 35 provides shear modulus and tear strength for the airship structure.

The type of monofilament employed in bias ply layer 35 is not particularly limited, and may be selected from any of the monofilaments described hereinabove for straight ply layer 25. In one embodiment, layer 35 includes Vectran® or an equivalent material.

In certain embodiments, bias ply layer 35 includes a woven or non-woven fabric that has warp and fill yarns as described for straight ply layer 25. In one embodiment, bias ply layer 35 may be stitch-bonded or knitted to straight ply layer 25 to eliminate the need for adhesive layer 30. It will be appreciated that the layers 25 and 35 may use any warp/fill pattern that maximizes strength while minimizing weight. Moreover, the layers 25 and 35 are not enclosed or embedded in any type of carrier material that would otherwise limit the flexibility, tear, or strength properties of the yarns used in the layers.

Barrier film layer 45 may include any high modulus film, such as polyamide, liquid crystal polymer, polyethylene teraphthalate (PET), polyethylene napthalate (PEN), and polyimide films. Examples of polyimide films include Kapton® or equivalent material. In general, modulus is a measure of resistance to extension of the fiber or the ratio of change in stress to the change in strain after the crimp has been removed from the fiber. An easily extensible fiber or film has low modulus. In certain embodiments, the high modulus film exhibits a tensile modulus of at least about 218,000 psi, in other embodiments, the tensile modulus is at least about 261,000 psi, in other embodiments, the tensile modulus is at least about 290,000 psi.

In one or more embodiments, high modulus barrier film layer 45 provides excellent bias modulus and is also an excellent gas barrier material to hold the preferred lighter-than-air material, such as helium, within the hull construction. In one embodiment, high modulus film layer 45 functions as a gas barrier for retaining helium or the like.

The thickness of barrier film layer 45 is not particularly limited. In one embodiment, film layer 45 is from about 0.3 to about 2 mils in thickness.

In one embodiment of the present invention, barrier film layer 45 includes reinforcing filler. Examples of reinforcing filler include carbon black, fumed silica, carbon nanotubes, carbon nanofibers, nanoclay, and the like. The amount of reinforcing filler added to the barrier film is not particularly limited, so long as it is an effective amount to increase the modulus of the barrier film layer. In one embodiment, barrier film layer 45 includes reinforcing filler in an amount of at least about 2 weight percent (wt. %), based upon the total weight of barrier film layer 45. In another embodiment, barrier film layer 45 includes reinforcing filler in an amount of at least about 5 weight percent (wt. %), based upon the total weight of barrier film layer 45. In certain embodiments, the barrier film includes reinforcing filler in an amount of from about 1 to about 20 wt. %, based upon the total weight of barrier film layer 45. In one or more embodiments, barrier film layer 45 includes reinforcing filler in an amount of from about 2 to about 10 wt. %, based upon the total weight of barrier film layer 45.

Metal coating layer 50 is adhered to the outer surface of high modulus film layer 45. Suitable metals include highly reflective metals such as silver, aluminum, gold, and copper. In one or more embodiments, metal coating layer 50 includes aluminum. Aluminum coated polyimide films are commercially available from Sheldahl Technical Materials of Northfield, Minn. Alternatively, high modulus film layer 45 may be coated with metal films and foils via processes generally known in the art. Processes to apply metals to Kapton® without adhesives are known, for example by vacuum metallization and sputtering techniques.

The thickness of metal coating layer 50 is not particularly limited, but should be sufficient to prevent transmittance of solar radiation. The coating may be in the form of a thin foil, vapor deposited film or sputtered film. In one embodiment, the thin foil is from about 0.2 to about 1 mil in thickness. In one or more embodiments, metal coating layer 50 is applied to a thickness of from about 800 to about 1200 angstroms, and in one embodiment, metal coating layer 50 is applied to a thickness of about 1000 angstroms.

One purpose of the metal coating is to reflect solar radiation for thermal management. Other purposes of the metal coating are to dissipate static charge buildup, reduce helium permeability, and reduce damage from lightning strikes.

Reflectance enhancing layer 52 may be adhered to metal coating layer 50. Reflectance enhancing layer 52 may include a polymer film such as 3M photonic filter films, or dielectric materials such as titanium dioxide, silicon dioxide, or hafnium dioxide. Layer 52 may enhance reflectance and/or provide a notch reflector for a specific band width of solar radiation. When employed, the polymer or dielectric coating 52 may be applied to a quarter-wavelength optical thickness (QWOT) or increments thereof. QWOT techniques include the process of applying successive layers of materials of differing refractive indexes, thereby increasing the reflectivity of the coating. The materials in the layers, the thicknesses of the layers, and the indices of refraction of the layers may be chosen to selectively reflect solar radiation within a certain wavelength range.

Optionally, clear film cover layer 55 is adhered to metal coating layer 50. When reflectance enhancing layer 52 is present, clear film cover layer 55 may be adhered to reflectance enhancing layer 52. Clear film cover layer 55 may include any film that is resistant to ozone and ultraviolet radiation. Useful films also include corrosion protector films. Examples of suitable films include polyvinylidene fluoride.

By “clear” it is meant that the film does not contain substantial amounts of pigments or solid materials that would cause the film to appear cloudy or opaque, or otherwise decrease the reflectivity of the metal coating layer.

In one or more embodiments, film cover layer 55 further includes a fluorescent dye. Any fluorescent dye that does not make the film cloudy or opaque, or otherwise detrimentally affect the properties of the film, may be used. Examples of fluorescent dyes include commercially available optical brighteners. In one embodiment, the fluorescent dye can be used in an inspection of film cover layer 55 to detect imperfections or damage in the cover layer. For example, ultraviolet or black light can be directed onto the laminate material. Areas that do not fluoresce indicate possible gaps or discontinuities in the cover layer.

Film cover layer 55 may be adhered to metal coating layer 50 or reflectance enhancing layer 52 by use of an adhesive, such as a thermoplastic or thermoset adhesive. Alternatively, film cover layer 55 may be directly cast onto metal coating layer 50 or reflectance enhancing layer 52. Therefore, in one or more embodiments, no adhesive layer is necessary between film cover layer 55 and metal coating layer 50 or reflectance enhancing layer 52. In one or more embodiments, the film cover material provides excellent ultraviolet and ozone protection while allowing reflectance of solar radiation from metal coating layer 50.

In certain embodiments, film cover layer 55 also enhances thermal control of the vehicle and reduces its infrared signature. In other words, metal layer 50 reflects about 85-95% of solar radiation in the ultraviolet, visible, and near infrared regions of the solar spectrum, while film cover layer 55 acts as an emitter in the mid to far infrared region to minimize heat build-up in the fabric hull material.

One or more layers 25, 35, 45 and 55 are bonded to one another with adhesive layers. Suitable adhesives include thermoplastic and thermosetting adhesives. Specific examples of adhesives include polyurethane adhesives that retain flexibility at low temperatures.

The adhesive material bonds the layers to one another and may fill in any pin holes or gaps that may be encountered. In one or more embodiments, the straight ply and bias ply layers are laminated such that penetration of the adhesive into the layers is minimized, and fabric stiffness or reduction in fabric tear strength is avoided. More specifically, the adhesive may be laid onto the surface of the yarn layers and is not embedded into the yarn.

One or more adhesive layer may include reinforcing fibers or inorganic fillers to enhance mechanical properties. Inorganic fillers include carbon black, fumed silica, carbon nanotubes, carbon nanofibers, nanoclay and the like. Advantageously, the addition of reinforcing filler may increase the strength and modulus of the laminating adhesive without significantly increasing its weight. In one or more embodiments, the greater strength contributed by the reinforced adhesive layer allows a reduction the monofilament yarns of bias ply layer 35, and this results in a reduced weight of bias ply layer 35.

Typically, a bias ply layer in a hull fabric for LTA vehicles has a weight of about 1.5 ounces per square yard (oz/yd²). Advantageously, the weight of bias ply layer 35 may be reduced according to the present invention. In one embodiment, the weight of bias ply layer 35 is from 0 to about 1 oz/yd². In one embodiment, the weight of bias ply layer 35 is reduced by about 50%, or to less than about 0.75 oz/yd². In another embodiment, the weight of bias ply layer 35 is completely eliminated.

In these or other embodiments, the laminated fabric including a reinforced adhesive layer and reduced bias ply layer has a higher strength to weight ratio than laminated fabric having a conventional bias ply layer but no reinforcing filler in the adhesive layers. In one embodiment, a conventional laminated fabric including a bias ply layer and having a strength to weight ratio of about 194 is modified by adding reinforcing filler to the barrier layer and reducing the weight of the bias ply layer by about 50 percent. The resulting strength to weight ratio is about 218. In another embodiment, the conventional laminated fabric is modified by eliminating the bias ply layer and adding reinforcing filler to the barrier film layer and the adhesive layer between the straight ply layer and the barrier layer. The resulting strength to weight ratio is about 259. In certain embodiments, the reinforcing filler in the adhesive layer improves adhesion to cloth layers, increases seam strength, or provides more even distribution of load around broken or damaged yarns.

In embodiments where barrier film layer 45 includes reinforcing filler, the weight of bias ply layer 35 may be reduced, while maintaining good strength. In certain embodiments, bias ply layer 35 and adhesive layer 30 may be completely eliminated, and the weight of the laminated hull fabric may be reduced by up to about 30 percent. In one embodiment, the weight of laminated hull fabric 20 is less than about 6.75 oz/yd², and in another embodiment, the weight of laminated hull fabric 20 is less than about 5.1 oz/yd² In one or more embodiments, the strength to weight ratio of hull fabric 20 is from about 218 to about 259.

As will be appreciated, the hull 12 and fins 14 are typically not made of a single piece of the laminate material 20. Accordingly, strips or patterns of the material are adjoined to one another while still providing all the properties of the laminate material. The method of joining strips is not particularly limited. In one or more embodiments, a butt joint configuration is used, such as that described in copending U.S. patent application Ser. No. 10/388,772, which is hereby incorporated by reference in its entirety. In other embodiments, other methods are used, such as sewing, splicing, adhesive tape, and the like.

Based on the foregoing, the advantages of the present laminate material construction are readily apparent. In particular, the present constructions provide for high strength and low weight characteristics which allow for maximum altitude of the lighter-than-air vehicle while providing light weight construction to increase the amount of payload that can be carried by the vehicle 10. Indeed, the preferred laminate or material weighs less than 8 ounces per square yard. The combination of the materials provides excellent permeability to retain the lighter-than-air gas. The present invention is also advantageous in that the materials are flexible and can withstand wide temperature variations ranging anywhere from −130° F. to +158° F. In certain embodiments, the barrier layer is reinforced to improve shear modulus of the fabric laminate, while the bias ply layer is reduced or eliminated to reduce fabric weight. In other embodiments, and adhesive layer includes reinforcing filler that improves shear modulus and tear strength of the fabric laminate.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A laminate material comprising:
at least one monofilament yarn layer;
a high modulus film layer adjacent to said at least one monofilament layer;
an adhesive disposed between said monofilament yarn layer and said high modulus film layer; and
a metallized coating adjacent to said high modulus film layer, wherein one or more of said adhesive and said high modulus film layer includes a reinforcing fiber or inorganic filler.

2. The laminate material according to claim 1, further comprising:
a substantially clear film cover layer adjacent to said metallized coating.

3. The laminate material according to claim 2, wherein said film cover layer comprises polyvinylidene fluoride.

4. The laminate material according to claim 1, wherein said monofilament yarn layer is a straight ply yarn layer.

5. The laminate material according to claim 1, further comprising:
a first ply yarn layer; and
a second ply yarn layer oriented at an angle of from about 30 to about 60 degrees to said first ply.

6. The laminate material according to claim 5, further comprising a first adhesive disposed between said yarn layers.

7. The laminate material according to claim 6, further comprising a second adhesive disposed between said second ply yarn layer and said high modulus film layer.

8. The laminate material according to claim 1, wherein said adhesive is selected from a group consisting of thermoplastic adhesives and thermosetting adhesives.

9. The laminate material according to claim 1, wherein said adhesive further comprises reinforcing fiber or inorganic filler.

10. The laminate material according to claim 1, wherein said reinforcing fiber or inorganic filler is selected from the group consisting of carbon black, fumed silica, carbon nanotubes, carbon nanofibers, and nanoclay.

11. A laminate material comprising:
a straight ply monofilament yarn layer;
a high modulus film layer secured to said straight ply layer, wherein said film layer comprises a reinforcing fiber or inorganic filler;
a metal coating layer secured to the high modulus film layer; and
a clear film cover layer secured to the metal coating layer.

12. The laminate material according to claim 11, wherein said straight ply layer includes a woven or non-woven construction having warp yarns and fill yarns.

13. The laminate construction according to claim 11, wherein said straight ply monofilament yarn layer includes polyamide, polyester, aramide, liquid crystal polymer fiber, carbon, polybenzoxazole, ultrahigh molecular weight polyethylene, or a mixture thereof.

14. The laminate material according to claim 11, wherein the high modulus film includes a polyimide.

15. The laminate material according to claim 11, wherein said reinforcing fiber or inorganic filler is selected from the group consisting of carbon black, fumed silica, carbon nanotubes, carbon nanofibers, and nanoclay.

16. The laminate construction according to claim 11, wherein said metal coating layer comprises one or more of silver, aluminum, gold, and copper.

17. The laminate construction according to claim 11, further comprising a reflectance enhancing layer adhered to said metal coating layer, wherein said reflectance enhancing layer comprises a multi-layer polymer film or dielectric film selected from titanium dioxide, silicon dioxide, or hafnium dioxide, and wherein said clear film cover layer is secured to said reflectance enhancing layer.

18. The laminate material according to claim 11, wherein said clear film cover layer comprises polyvinylidene fluoride.

19. A laminate material comprising:
at least one monofilament yarn layer;
a high modulus film layer secured to said yarn layer with an adhesive layer therebetween, wherein said adhesive layer comprises a reinforcing fiber or inorganic filler;
a metal coating layer secured to the high modulus film layer; and
a clear film cover layer secured to the metal coating layer.

20. The laminate material according to claim 19, wherein said monofilament yarn layer includes a straight ply monofilament yarn layer and a bias ply monofilament yarn layer secured to said straight ply layer with an adhesive layer therebetween, wherein said adhesive layer comprises a reinforcing fiber or inorganic filler;

21. A lighter-than-air vehicle, comprising:
a hull;
said hull including at least one piece of laminate material comprising:
a straight ply monofilament yarn layer;
a high modulus film layer secured to said straight ply layer; and
a metal coating layer secured to said high modulus film layer.

22. The vehicle according to claim 21, wherein said film layer comprises a reinforcing fiber or inorganic filler.

23. The vehicle according to claim 21, wherein said laminate further comprises:
polyurethane adhesive disposed between said straight ply layer and said high modulus film layer.

24. The vehicle according to claim 23, wherein said adhesive comprises a reinforcing fiber or inorganic filler.

25. The vehicle according to claim 21, wherein the metal coating layer comprises one or more of silver, aluminum, gold, and copper.

26. The vehicle according to claim 21, wherein said straight ply layer is a woven, non-woven, knit or stitch-bonded construction having warp yarns and fill yarns.

27. The vehicle according to claim 21, wherein said high modulus layer comprises a polyimide.

28. The vehicle according to claim 21, further comprising a reflectance enhancing layer adhered to said metal coating layer.

29. The vehicle according to claim 21, further comprising a clear cover layer adhered to said reflectance enhancing layer.
